(19) United States
(12) Patent Application Publication
(10) Pub. No.: US 2007/0272666 A1
(43) Pub. Date: Nov. 29, 2007

(54) Infrared laser wafer scribing using short pulses

(76) Inventors: James N. O'Brien, Bend, OR (US); Peter Pirogovsky, Portland, OR (US)

Correspondence Address: ELECTRO SCIENTIFIC INDUSTRIES/STOEL RIVES, LLP, 900 SW FIFTH AVE., SUITE 2600, PORTLAND, OR, 97204-1268, US

(21) Appl. No.: 11/441,454

(22) Filed: May 25, 2006

(51) Int. Cl. B23K 26/38; B23K 26/40

(52) U.S. Cl. 219/121.69; 219/121.72; 438/463

(57) ABSTRACT

Systems and methods are provided for scribing wafers to efficiently ablate passivation and/or encapsulation layers while reducing or eliminating chipping and cracking in the passivation and/or encapsulation layers. Short laser pulses are used to provide high peak powers and reduce the ablation threshold. In one embodiment, the scribing is performed by a q-switched CO₂ laser.

### TECHNICAL FIELD

This application relates to laser cutting or scribing and, in particular, to a method for scribing a finished semiconductor wafer using a q-switched laser so as to reduce or eliminate chipping and cracking.

### BACKGROUND INFORMATION

Integrated circuits (ICs) are generally fabricated in an array on or in a semiconductor substrate. ICs generally include several layers formed over the substrate. One or more of the layers may be removed along scribing lanes or streets using a mechanical saw or a laser. After scribing, the substrate may be throughout, sometimes called diced, using a saw or laser to separate the circuit components from one another. A combination of laser scribing with consecutive mechanical sawing is also used for dicing.

However, conventional mechanical and laser cutting methods are not well suited for scribing many advanced finished wafers with, for example, isolation or encapsulation layers and/or low-k dielectric layers. FIGS. 1A-1C 1B are electron micrographs of edges 110, 112, 113 cut in finished wafers 114, 116, 118 using a conventional saw. As shown, the finished wafers near the edges 110, 112, 113 are chipped and cracked. Relatively low density, lack of mechanical strength and sensitivity to thermal stress make low-k dielectric material very sensitive to stress. Conventional mechanical wafer dicing and scribing techniques are known to cause chips, cracks and other types of defects in low-k materials, thus damaging the IC devices. To reduce these problems, cutting speeds are reduced. However, this severely reduces throughput.

Laser scribing techniques have many advantages over mechanical sawing. However, known laser techniques can produce excessive heat and debris. Excessive heat diffusion can cause heat affected zones, recast oxide layers, excessive debris and other problems. Cracks may form in the heat affected zone and may reduce the die break strength of the semiconductor wafer. Thus, reliability and yield are reduced. Further, debris is scattered across the surface of the semiconductor material and may, for example, contaminate bond pads. In addition, conventional laser cutting profiles may suffer from trench backfill of laser ejected material. When the wafer thickness is increased, this backfill becomes more severe and reduces dicing speed. Further, for some materials under many process conditions, the ejected backfill material may be more difficult to remove on subsequent passes than the original target material. Thus, cuts of low quality are created that can damage IC devices and require additional cleaning and/or wide separation of the devices on the substrate.

Conventional laser scribing techniques include, for example, using continuous wave (CW) CO₂ lasers with wavelengths in the mid-infrared range. However, such CW lasers are difficult to focus and generally require high energies to ablate IC processing materials. Thus, excessive heating and debris are produced. Pulsed CO₂ lasers have also been used for scribing. However, such scribing techniques use long pulses generally in the millisecond range. Thus, low peak power is produced by the long pulses and high energies per pulse are used to ablate material. Accordingly, the long pulses allow excessive heat diffusion that causes heat affected zones, recast oxide layers, excessive debris, chipping and cracking.

Another conventional laser scribing technique includes, for example, using lasers having wavelengths ranging from approximately 1064 nm to approximately 266 nm. However, outer passivation and/or encapsulation layers are generally partially transparent to these wavelengths. For example, the first part of a pulse at these wavelengths may pass through the upper passivation and/or encapsulation layers without being absorbed. However, the pulses are absorbed by subsequent metallic and/or dielectric layers. Thus, the subsequent layers can heat and explode before the upper passivation and/or encapsulation layers can be ablated by the laser. This causes the passivation and/or encapsulation layers to peel or crack off and spread debris. FIGS. 2A and 2B are electron micrographs of kerfs 210, 212 scribed in wafers 214, 216 using conventional Gaussian laser pulses having pulse widths in the picosecond range. As shown, portions of the wafers 210, 212 near the edges of the kerfs 210, 212 are chipped and cracked.

A method for laser scribing that reduces or eliminates chipping, cracking and debris, and that increases throughput and improves cut surface or kerf quality is, therefore, desirable.

### SUMMARY OF THE DISCLOSURE

The present invention provides methods of laser scribing a finished wafer so as to efficiently ablate passivation and/or encapsulation layers while reducing or eliminating chipping and cracking in the passivation and/or encapsulation layers. Short laser pulses are used to provide high peak powers and reduce the ablation threshold. In one embodiment, the scribing is performed by a q-switched CO₂ laser.

In one embodiment, a method is provided for scribing a substrate having a plurality of integrated circuits formed thereon or therein. The integrated circuits are separated by one or more streets. The method includes generating one or more laser pulses having a wavelength and a pulse width duration. The wavelength is selected such that the one or more pulses are substantially absorbed by target material comprising at least one of a passivation layer and an encapsulation layer formed over the substrate. The wavelength is further selected such that the substrate is substantially transparent to the one or more pulses. The pulse width duration is selected so as to reduce the ablation threshold of the target material.

In another embodiment, a method is provided for scribing a semiconductor wafer. The method includes ablating a portion of one or more layers formed over the semiconductor wafer with one or more laser pulses having a wavelength in a range between approximately 9 μm and approximately 11 μm. The one or more laser pulses have a pulse width duration in a range between approximately 130 nanoseconds and approximately 170 nanoseconds. In one embodiment, the semiconductor wafer comprises silicon. In another embodiment, the semiconductor wafer comprises germanium.

Additional aspects and advantages will be apparent from the following detailed description of preferred embodiments, which proceeds with reference to the accompanying drawings.

### BRIEF DESCRIPTION OF THE DRAWINGS

FIGS. 1A-1C are electron micrographs of kerfs cut through finished wafers using a conventional mechanical saw.

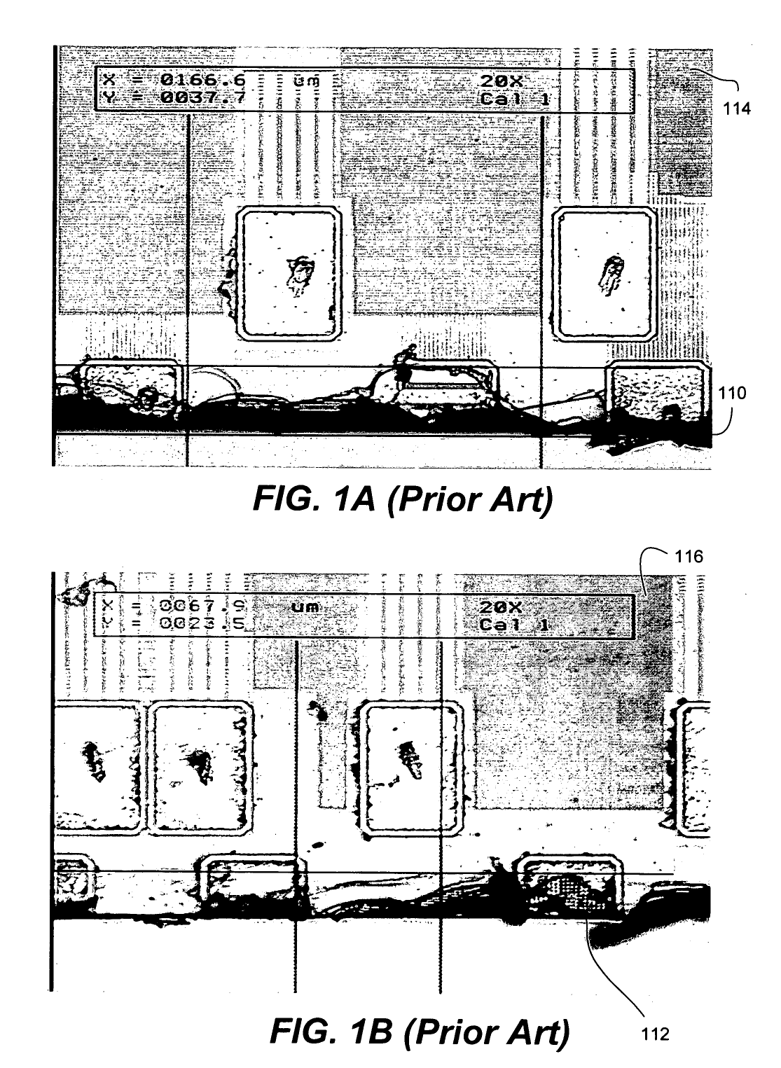

FIGS. 2A and 2B are electron micrographs of kerfs scribed in finished wafers using lasers with wavelengths of approximately 1064 nm and 355 nm, respectively.

FIG. 3 is a side view schematic of an exemplary work piece that is scribed according to certain embodiments of the invention.

FIGS. 4A and 4B are side view schematics illustrating the work piece of FIG. 3 processed according to conventional laser scribing techniques.

FIGS. 5A and 5B are side view schematics illustrating the work piece of FIG. 3 scribed with a q-switched CO₂ laser according to certain embodiments of the invention.

FIGS. 6A-6C are electron micrographs of kerfs scribed through passivation/encapsulation layers using a q-switched CO₂ laser according to certain embodiments of the invention.

FIG. 7 is an electron micrograph of a kerf scribed through passivation/encapsulation layers using a q-switched CO₂ laser and a Gaussian picosecond pulse laser beam according to an embodiment of the invention.

### DETAILED DESCRIPTION OF PREFERRED EMBODIMENTS

The ability of a material to absorb laser energy determines the depth to which that energy can perform ablation. Ablation depth is determined by the absorption depth of the material and the heat of vaporization of the material. Parameters such as wavelength, pulse width duration, pulse repetition frequency, and beam quality can be controlled to improve cutting speed and the quality of the cut surface or kerf. In one embodiment, one or more of these parameters are selected so as to increase energy absorption in outer passivation and/or encapsulation layers and reduce the amount of fluence (typically measured in J/cm²) required to ablate the passivation/encapsulation layers and/or additional layers(referred to herein as “ablation threshold.”) Thus, the amount of excessive energy deposited into the material is reduced or eliminated. Further, using a lower fluence reduces or eliminates recast oxide layers, heat affected zones, chipping, cracking, and debris. Thus, die break strength is increased and the amount of post-laser cleaning required is decreased.

In one embodiment, laser pulses having a wavelength in a range between approximately 9 μm and approximately 11 μm are used to scribe a finished semiconductor wafer. At these wavelengths, the passivation and encapsulation layers are configured to absorb a large portion of the pulse energy. Thus, the passivation and encapsulation layers are ablated before being cracked and blown off due to ablation of lower layers. Further, silicon substrates absorb very little pulse energy at these wavelengths. Thus, there is very little or no substrate heating that can cause cracking.

The laser pulses have short pulse widths in a range between approximately 130 nanoseconds and approximately 170 nanoseconds. In one embodiment, a q-switched CO₂ laser is used to generate the laser pulses. An artisan will recognize that q-switching is a technique used to obtain energetic short pulses from a laser by modulating the quality factor of the laser cavity. Using the q-switched short pulse CO₂ laser eliminates or significantly reduces chipping and cracking during wafer scribing and wafer dicing processes.

The short pulse widths are selected to provide higher peak energy than that of continuous wave (CW) pulses or long pulse widths. U.S. Pat. No. 5,656,186 to Mourou et al. teaches that the ablation threshold of a material is a function of laser pulse width. CW pulses or pulses with long pulse widths (e.g., in the millisecond range) generally require a higher ablation threshold as compared to that of shorter pulse widths. Shorter pulses increase peak power and reduce thermal conduction. Thus, scribing finished wafers using the short pulses is more efficient. The result is a faster scribing process.

For convenience, the term cutting may be used generically to include scribing (cutting that does not penetrate the full depth of a target work piece) and throughcutting, which includes slicing (often associated with wafer row separation) or dicing (often associated with part singulation from wafer rows). Slicing and dicing may be used interchangeably in the context of this invention.

Reference is now made to the figures in which like reference numerals refer to like elements. For clarity, the first digit of a reference numeral indicates the figure number in which the corresponding element is first used. In the following description, numerous specific details are provided for a thorough understanding of the embodiments of the invention. However, those skilled in the art will recognize that the invention can be practiced without one or more of the specific details, or with other methods, components, or materials. Further, in some cases, well-known structures, materials, or operations are not shown or described in detail in order to avoid obscuring aspects of the invention. Furthermore, the described features, structures, or characteristics may be combined in any suitable manner in one or more embodiments.

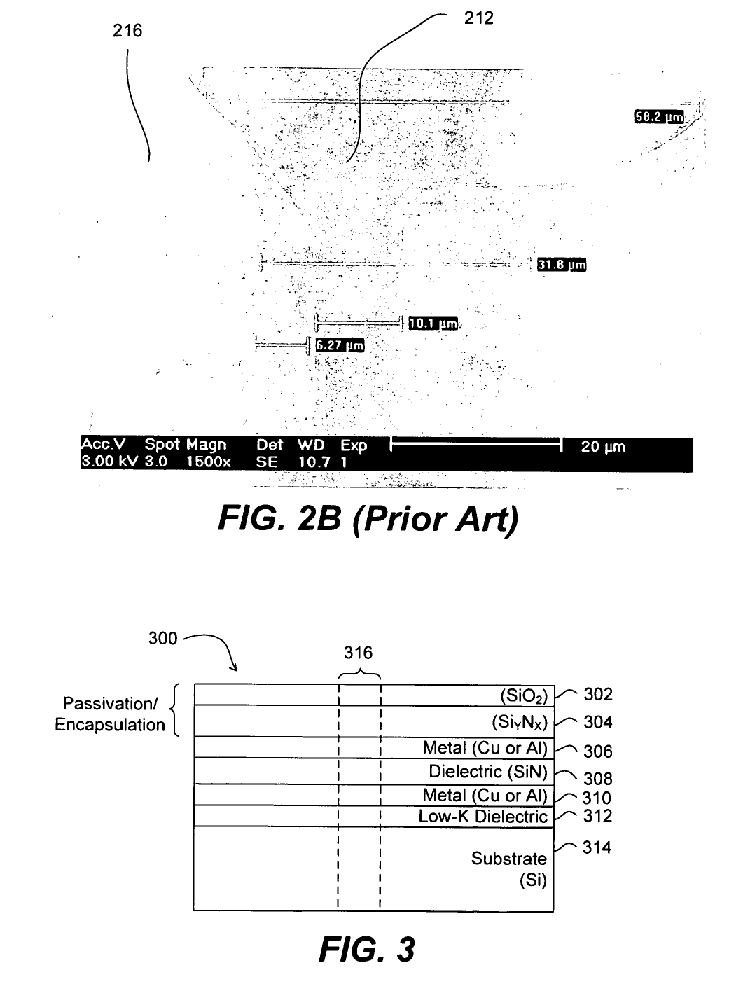

FIG. 3 is a side view schematic of an exemplary work piece 300 that is scribed according to certain embodiments of the invention. The work piece 300 includes a first layer 302, a second layer 304, a third layer 306, a fourth layer 308, a fifth layer 310, and a sixth layer 312 formed over a substrate 314. As an artisan will recognize, the layers 302, 304, 306, 308, 310, 312 may include interconnect layers separated by insulation layers, including low-k dielectrics, to form electronic circuitry. In this example, the top two layers 302, 304 form a passivation and encapsulation layer. The first layer 302 may include, for example, silicon dioxide (SiO₂) and the second layer 304 may include a silicon-nitride (Si_{Y}N_{X}). For example, the second layer 304 may include Si₄N₃. An artisan will recognize that other materials can be used to form passivation and/or encapsulation layers.

In this example, the third layer 306 comprises a metal (e.g., Cu or Al), the fourth layer 308 comprises a dielectric (e.g., SiN), the fifth layer 310 comprises a metal (e.g., Cu or Al), and the sixth layer 312 comprises a low-k dielectric. Low-k dielectric materials may include, for example, an inorganic material such as SiOF or SiOB or an organic material such as polymide-based or parylene-based polymer. An artisan will recognize that the materials discussed for the layers 306, 308, 310, 312 are for example only and that other types of could also be used. Further, an artisan will recognize that more layers or less layers can be used for particular ICs. As shown, the substrate 314 comprises silicon (Si). However, an artisan will also recognize that other materials useful in IC manufacture can be used for the substrate 314 including, for example, glasses, polymers, metals, composites, and other materials. For example, the substrate 314 may include FR4.

As discussed above, the layers 302, 304, 306, 308, 310, 312 form electronic circuitry. Individual circuits are separated from each other by a scribing lane or street 316 (shown in FIG. 3 as two vertical dashed lines). To create individual ICs, the work piece 300 is scribed, throughout, or both, along the street 316. In certain embodiments, the work piece 300 is scribed by ablating one or more of the layers 302, 304, 306, 308, 310, 312 with a beam of laser pulses. Advantageously, the laser scribing process discussed herein creates a clean kerf with substantially uniform side walls in the region of the street 316 with little or no cracking or chipping in regions outside the street 316 that are common with typical laser scribing processes.

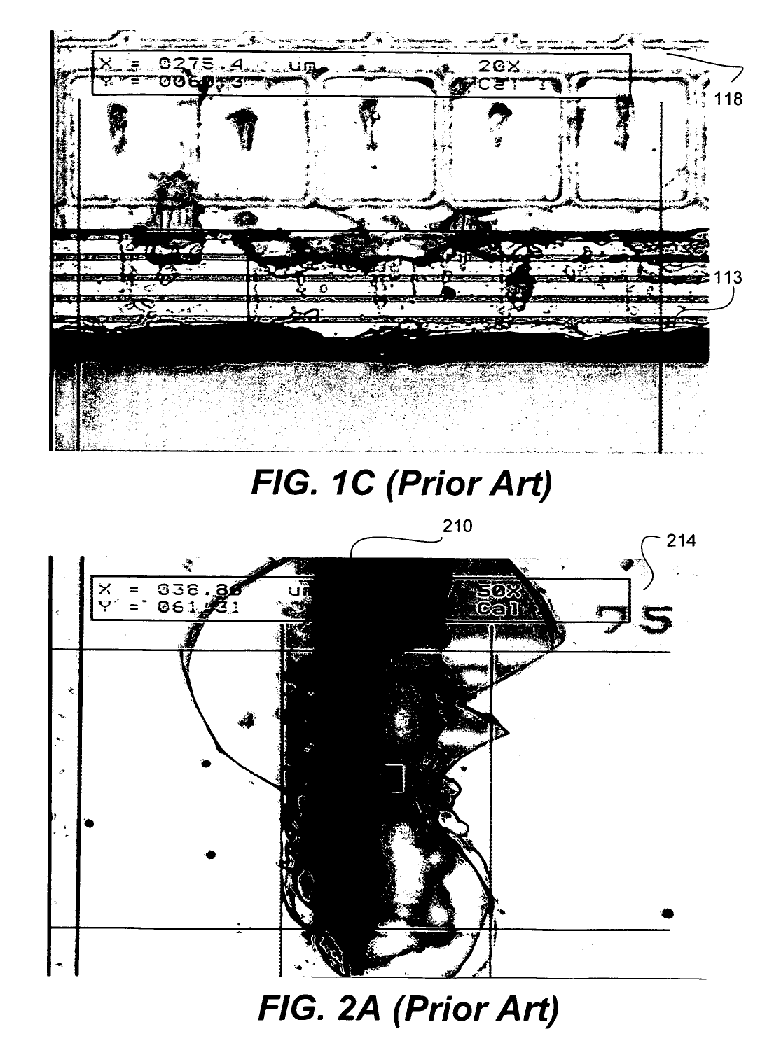

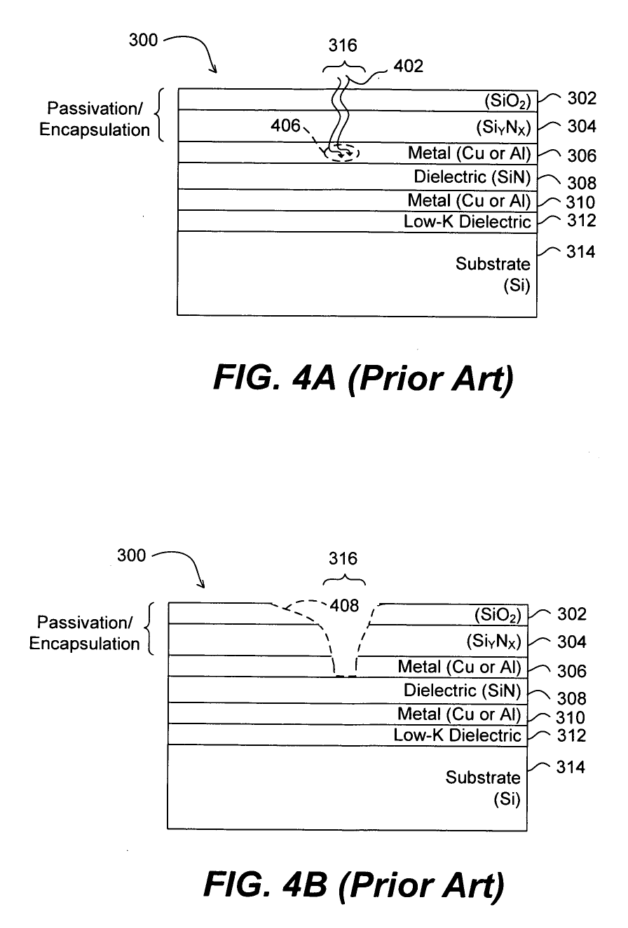

FIGS. 4A and 4B, for example, are side view schematics illustrating the work piece 300 of FIG. 3 processed according to conventional laser scribing techniques. FIG. 4A shows laser pulse energy 402 (e.g., at wavelengths ranging from approximately 1064 nm to approximately 266 nm) passing through the passivation/encapsulation layers 302, 304 with little or no absorption. Rather, the laser pulse energy 402 is absorbed in a region 406 of the third layer 306 which causes the region 406 to heat up. Eventually, the heat causes the region 406 to ablate or explode. Thus, portions of the layers 302, 304 are blown off. FIG. 4B schematically illustrates a kerf 408 produced by the explosion. The kerf 408 does not have uniform sidewalls and extends (in chips) outside of the street area 316, which may damage the ICs. As discussed above, FIGS. 2A and 2B illustrate such chipping.

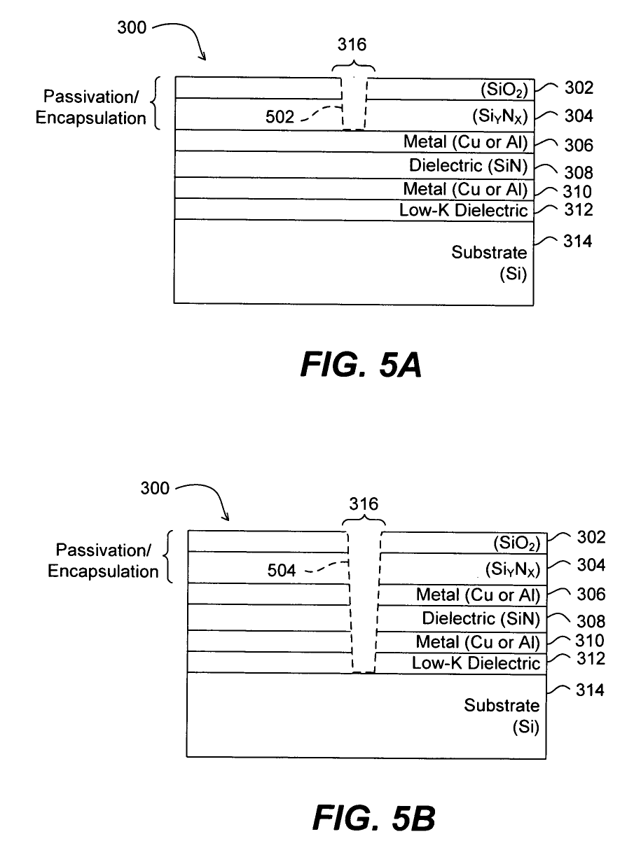

FIGS. 5A and 5B are side view schematics illustrating the work piece 300 of FIG. 3 scribed with a q-switched CO₂ laser according to certain embodiments of the invention. The CO₂ laser provides a laser beam comprising a series of laser pulses having a wavelength in a range between approximately 9 μm and approximately 11 μm, and a pulse width duration in a range between approximately 130 nanoseconds and approximately 170 nanoseconds.

The passivation/encapsulation layers 302, 304 are configured to absorb the energy of the pulses produced by the CO₂ laser. Further, the short pulses have high peak energies that quickly and efficiently ablate the passivation/encapsulation layers 302, 304 to produce clean kerfs with substantially uniform sidewalls. In addition, the silicon substrate 314 is substantially transparent to the wavelengths of the pulses produced by the CO₂ laser. Thus, the substrate 314 absorbs little or none of the energy of the pulses produced by the CO₂ laser and experiences very little or no heating.

As shown in FIG. 5A, in one embodiment, the CO₂ laser is used to scribe the work piece 300 by ablating the passivation/encapsulation layers 302, 304 to create a kerf 502 in the area of the street 316. The kerf 502 has substantially uniform sidewalls and a substantially flat bottom. In some embodiments, the wavelengths produced by the CO₂ laser are not as efficient at ablating metal (e.g., the layers 306, 310) as it is at ablating the passivation/encapsulation layers 302, 304. Thus, as shown in the embodiment of FIG. 5A, the CO₂ laser is only used to ablate the passivation/encapsulation layers 302, 304.

The remaining layers 306, 308, 310, 312 may be scribed using conventional sawing or laser scribing techniques. For example, the layers 306, 308, 310, 312 may be scribed using near infrared pulses in the picosecond range. The substrate 314 may also be diced using conventional sawing or laser ablation techniques. For example, a laser having a wavelength of approximately 266 nm can be used to efficiently and cleanly dice the substrate 314.

As shown in FIG. 5B, in another embodiment, the CO₂ laser is used to scribe the work piece 300 by ablating the layers 302, 304, 306, 308, 310, 312 to create a kerf 504 in the area of the street 316. Again, the kerf 504 has substantially uniform sidewalls and a substantially flat bottom. While wavelengths ranging from approximately 9 μm to approximately 11 μm are less efficient at ablating metals, they can still ablate metals after sufficient heating. Thus, in the embodiment shown in FIG. 5B, the CO₂ laser discussed herein can be used as a single process to create the kerf 504 extending from the top surface of the first layer 302 to the top surface of the substrate 314. As discussed above, the silicon substrate is substantially transparent to the wavelengths in the range between approximately 9 μm to approximately 11 μm. Thus, it is very inefficient to dice the substrate 314 with the CO₂ laser. Therefore, after scribing, the substrate 314 can be diced using conventional sawing or laser ablation techniques.

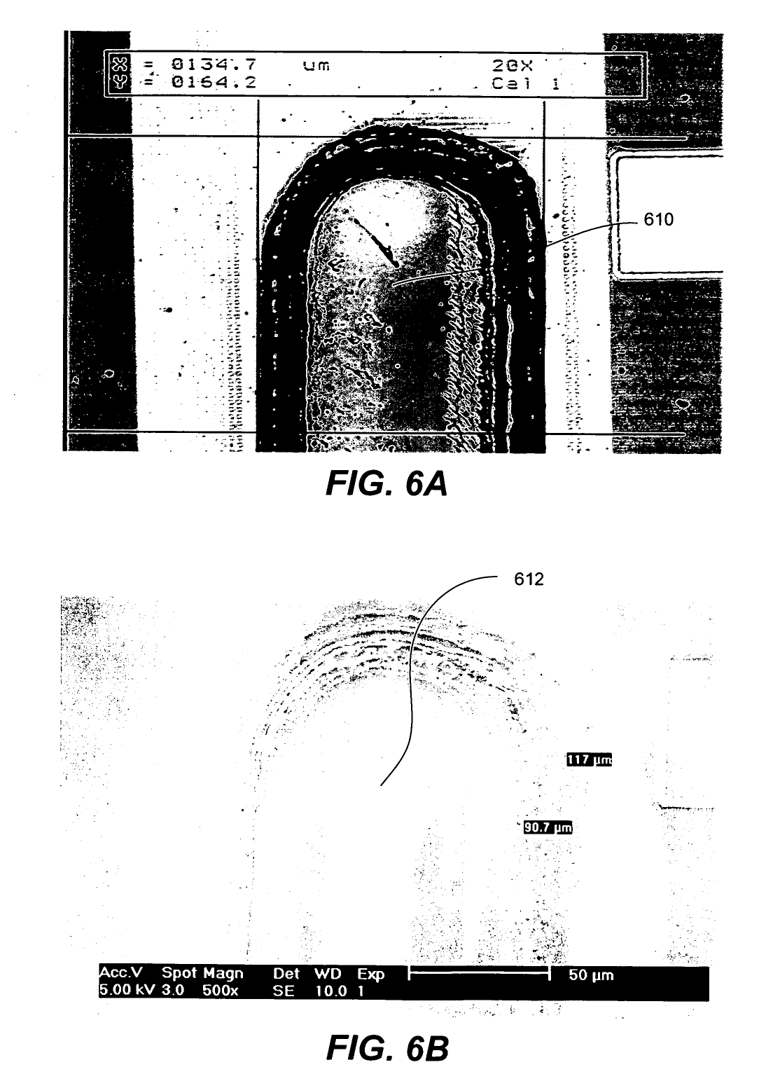

FIGS. 6A-6C are electron micrographs of kerfs 610, 612, 614 scribed through passivation/encapsulation layers using a q-switched CO₂ laser according to certain embodiments of the invention. As discussed above, the CO₂ laser produced laser pulses having a wavelength in a range between approximately 9 μm and approximately 11 μm, and a pulse width duration in a range between approximately 130 nanoseconds and approximately 170 nanoseconds. In FIGS. 6A-6C it can be observed that there is little or no chipping, cracking or contamination. Thus, higher die break strengths and overall process yields are achieved.

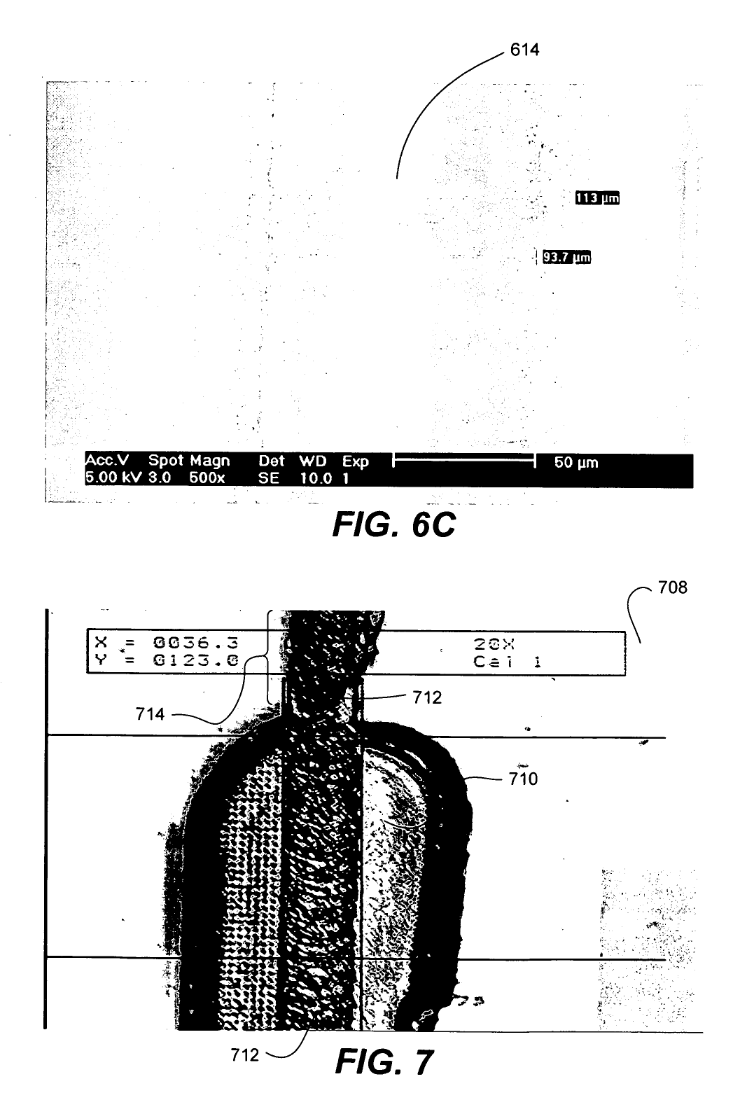

FIG. 7 is an electron micrograph of a finished semiconductor wafer 708 scribed with a q-switched CO₂ laser and a Gaussian picosecond pulse laser beam according to an embodiment of the invention. As shown in FIG. 7, a q-switched laser scribes a first kerf 710 in passivation/encapsulation layers of the finished wafer 708. Then, a Gaussian picosecond pulse laser beam scribes a second kerf 712 through additional layers of the finished wafer 708. For illustrative purposes, the second kerf 712 also extends beyond the first kerf 710 in an area 714. Where the finished wafer 708 is first scribed with the q-switched CO₂ laser, the kerfs 710, 712 have smooth edges and produce little or no cracking. However, in the area 714 where the q-switched CO₂ laser was not used, the Gaussian picosecond pulse laser produced cracking in the passivation/encapsulation layers.

It will be obvious to those having skill in the art that many changes may be made to the details of the above-described embodiments without departing from the underlying principles of the invention. The scope of the present invention should, therefore, be determined only by the following claims.

What is claimed is:

1. A method of scribing a substrate having a plurality of integrated circuits formed thereon or therein, the integrated circuits separated by one or more streets, the method comprising:
generating one or more laser pulses having a wavelength and a pulse width duration;
wherein the wavelength is selected such that the one or more pulses are substantially absorbed by target material comprising at least one of a passivation layer and an encapsulation layer formed over the substrate;
wherein the wavelength is further selected such that the substrate is substantially transparent to the one or more pulses; and
wherein the pulse width duration is selected so as to reduce the ablation threshold of the target material.

2. The method of claim 1, further comprising generating the one or more laser pulses with a CO₂ laser.

3. The method of claim 2, further comprising q-switching the CO₂ laser.

4. The method of claim 1, wherein the wavelength is in a range between approximately 9 μm and approximately 11 μm.

5. The method of claim 1, wherein the pulse width duration in a range between approximately 130 nanoseconds and approximately 170 nanoseconds.

6. The method of claim 1, wherein the at least one of a passivation layer and an encapsulation layer comprises silicon dioxide.

7. The method of claim 1, wherein the at least one of a passivation layer and an encapsulation layer comprises silicon-nitride.

8. The method of claim 1, wherein the substrate comprises silicon.

9. The method of claim 1, further comprising ablating a portion of a metallic layer formed over the substrate with the one or more laser pulses.

10. An integrated circuit scribed according to the method of claim 1.

11. A method of scribing a semiconductor wafer, the method comprising:
ablating a portion of one or more layers formed over the semiconductor wafer with one or more laser pulses having a wavelength in a range between approximately 9 μm and approximately 11 μm;
wherein the one or more laser pulses have a pulse width duration in a range between approximately 130 nanoseconds and approximately 170 nanoseconds.

12. The method of claim 11, wherein the one or more layers comprise at least one of a passivation layer and an encapsulation layer.

13. The method of claim 12, wherein the at least one of a passivation layer and an encapsulation layer comprises silicon dioxide.

14. The method of claim 12, wherein the at least one of a passivation layer and an encapsulation layer comprises silicon-nitride.

15. The method of claim 11, further comprising generating the one or more laser pulses using a CO₂ laser.

16. The method of claim 15, further comprising q-switching the CO₂ laser.

17. The method of claim 11, further comprising ablating a portion of a metallic layer with one or more laser pulses.

18. The method of claim 11, wherein the semiconductor wafer is substantially transparent to the one or more laser pulses.

19. The method of claim 18, wherein the semiconductor wafer comprises silicon.

20. An integrated circuit scribed according to the method of claim 11.
